(19) United States
(12) Patent Application Publication
(10) Pub. No.: US 2002/0099683 A1
(43) Pub. Date: Jul. 25, 2002

(54) Verification of a benefit purchase incident to a computer system purchase

(76) Inventors: Jeffrey N. Sloan, Round Rock, TX (US); Gary W. Cobb, Austin, TX (US)

Correspondence Address: HAMILTON & TERRILE, LLP, P.O. BOX 203518, AUSTIN, TX, 78720, US

(21) Appl. No.: 09/768,434

(22) Filed: Jan. 24, 2001

(51) Int. Cl. G06F 7/00

(52) U.S. Cl. 707/1

(57) ABSTRACT

A service tag is generated and stored on a computer when a make-to-order computer is assembled. When a user receives a computer and attempts to access the internet, a unique number, the service tag, is provided by the computer to an internet service provider's (ISP's) host server. The host server provides the key to a proprietary server, such as a server operated by the manufacturer of the computer. The proprietary server compares the service tag number received from the ISP server to a list of valid service tag numbers. If the service tag number is valid the proprietary server returns a purchase plan to the ISP server, allowing the user to obtain previously agreed benefits. One embodiment provides internet access as the previously agreed benefits.

### BACKGROUND OF THE INVENTION

1. Field of the Invention

This invention relates generally to computers and more specifically to benefit purchases incident to purchase of a computer system. The invention includes, but is not limited to a method, a process and a system.

2. Description of the Related Art

Computer manufacturers are increasingly assembling and configuring computer systems conforming to the specifications requested by the purchaser at the time of sale. During the transaction, the purchaser specifies the desired components of the computer system being ordered. When the computer is assembled and configured at the factory, the computer manufacturer utilizes the information provided by the purchaser during the order transaction to assemble and configure the computer system according to the purchaser's specifications.

Computer manufacturers offer services, products, and other benefits along with the purchase of a computer. A purchaser can specify the desired components of the computer system during the order transaction, and can also specify additional services, products, or benefits. These additional benefits may be paid for individually or included in the purchase price of the computer. For example, when the purchaser orders a computer system he can also order services provided by an Internet Service Provider (“ISP”). Thus, access to the internet may be agreed when the purchaser purchases the computer system. The price may either be separate or included in the base price of the computer system purchased.

ISP services are related to communications that occur over the Internet. The Internet is a vast system of computers and computer networks that are interconnected through communication links. The interconnected computers exchange information, which may include information necessary to conduct purchases and other commercial activities over the Internet.

A key component of the individual networks and organizations that make up the Internet are the individual local networks that provide access for individual users, known as Internet Service Providers (“ISP's”). An individual user that wishes to access the Internet pays the ISP a fee, such as a monthly connection rate. In return, the ISP acts as the intermediary between the user and the network “backbone” servers that provide access to the various networks that make up the Internet.

The practice of offering additional products, services, and benefits along with the purchase of a computer system raises several security, logistics, and customer experience concerns. One such concern arises from the fact that a purchaser of the manufacturer's computer systems may or may not order the pre-paid ISP service or other offered products and services. It is therefore necessary to devise a means by which the ISP or other provider of goods or services can determine, when the purchaser attempts to access the ISP or other provider, whether or not the purchaser has pre-paid for particular goods or services that the purchaser is requesting. Another concern is that the ISP or other provider must have a manner of identifying the purchaser. If the purchaser has pre-paid for a limited amount of monthly ISP access or a limited amount of other goods or services, the provider must identify the purchaser so that goods or services requested in an amount exceeding the prepaid amount may be tracked and charged to the proper person. Ideally, these concerns should be addressed in a way that minimizes implementation costs and requires as little action as possible from the purchaser.

One approach for addressing the above concerns is to issue a “product key” to the purchaser that encodes whether or not the purchaser has pre-paid for goods or services and, if so, identifies the good or services. U.S. patent application Ser. No. 09/522,200 filed on Feb. 23, 2000 by Bueche (Bueche) discloses such a method and is incorporated by reference for all purposes. Installing a product key during manufacture presents several disadvantages. A product key may be either printed and included in the packaging with the computer or may be installed with the software when the computer is manufactured. If the product key is printed and included in the packaging with the computer, the customer will be denied access unless he properly types the product key into the computer when it is requested. Therefore, a typographical error prevents the purchaser from accessing goods or services for which he has already paid.

If a product key is printed on a paper certificate and the paper certificate shipped with the computer, there is also the risk that the paper certificate bearing the printed product key will become destroyed, lost, or otherwise inaccessible to the purchaser. With a product key incorporated into the computer's software when the computer is manufactured, a user may be denied access to goods and services purchased if he erases, or formats, the computer hard drive or other storage medium before accessing the benefits associated with the product key. Finally, a user may read the product key and use the key to obtain benefits to which he is not entitled. Features of the present invention address these shortcomings.

### SUMMARY OF THE INVENTION

A service tag number is generated and stored in a computer memory when a make-to-order computer is assembled. When the purchaser (user) receives the computer and attempts to access the Internet, a unique identifier, the service tag, is provided by the computer to the Internet service provider's (ISP's) host server. The host server then transmits the key to a second (proprietary) server, such as a server operated by the manufacturer of the computer. The proprietary server compares the service tag number received from the ISP server to a list of valid service tag numbers. If the service tag number is valid (there is a match) the proprietary server returns a purchase plan to the ISP server, allowing the user to obtain previously agreed benefits. An embodiment of the invention provides Internet access as the previously agreed benefits.

The method disclosed does not require a product key stored in the memory of the purchased computer and therefore reduces the opportunity for a user to circumvent safe guards and obtain benefits for which he has not paid. Unlike other methods, the present method remains operable if the user formats the computer hard disk memory without first obtaining access to the internet, or other purchased benefits. Unlike other methods the method does not depend on the user accurately typing in a product key to gain access to purchased benefits.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a block diagram depicting a computer system suitable for implementing embodiments of the process.

FIG. 2 is a block diagram of a network environment, such as the internet. FIG. 2 is a block diagram illustrating a network environment in which embodiments of the present invention may be practiced.

FIG. 3 is a flow diagram depicting the logical steps of the method on a server operated by an Internet Service Provider.

FIG. 4 is a flow diagram depicting the logical steps of the method on a proprietary computer system, such as a computer system operated by a computer manufacturer.

FIG. 5 is a flow diagram depicting the logical steps of the method on a computer system purchased by a computer user.

### DETAILED DESCRIPTION

The following is intended to provide a detailed description of an example of the invention and should not be taken to be limiting of the invention itself. Rather, any number of variations may fall within the scope of the invention defined in the claims following the description. It is to be understood that the present invention may be utilized to verify and authorize on-line access to any service, product, or benefit that has been pre-paid with the order of a computer system, where “computer system” includes, e.g., a personal digital assistant (PDA) or other internet appliance. Services, products and benefits which include, but are not limited to, ISP services. For simplicity, the discussion below presents one embodiment, wherein the pre-paid benefit is ISP service. It will be understood, however, that many other types of pre-paid services, products, and benefits fall within the scope of the process claimed, such as access to on-line or standalone software, on-site or on-line technical support or maintenance agreements, and on-line banking, stock trading, bill-paying or other financial services.

Similarly, a conventional (stand alone or desk top) computer system is used here as an example of a make-to-order computer system. However, the method is applicable to any computing system having access to the internet. When a user agrees to purchase a make-to-order computer system, the user contacts the computer system vendor. The user (also referred to as a purchaser) specifies the desired computer system. Incident to the transaction the purchaser also identifies the desired benefit. As the transaction concludes the purchaser agrees to pay for the computer system and the benefit. The transaction may be in person, by telephone, facsimilie, email, over a network such as the internet, or by conventional mail.

Bueche teaches a method, apparatus and system for verifying the purchase of a benefit using a service tag and a product key, or Pkey. The product key is stored in the memory of a computer system when the computer system is assembled. When a user attempts to access a server from his computer through a connection to the internet, the server attempts to verify the product key. If the product key is verified, a user is allowed access to the benefit. The Bueche approach has several disadvantages identified above. These disadvantages may be addressed by a method for purchase verification which allows a manufacturer or vendor to verify with more accuracy that a purchaser is entitled to receive a benefit.

The method disclosed in the present application employs a second server which is, e.g,. operated and maintained by the computer system manufacturer. Employing a second server a manufacturer or vendor to more accurately determine whether or not a purchaser is allowed to receive a benefit. In one embodiment the method may be practiced using a service tag installed on a computer at the time of manufacture of the computer. In another embodiment, a service tag is installed in conjunction with a product code, also installed at the time the computer system is manufactured. “Server” here refers to conventional server software executed on a server computer platform, e.g., of the “Wintel” type supplied by International Business Machines (IBM), Dell Computer Corporation and others. Other examples of servers include Linux or Unix-based servers also supplied by Dell Computer Corporation, Internal Business Machines (IBM) and others.

The method may be practiced using a conventional desktop computer system as the computer system purchased. However, as discussed above, the use of such a computer system as an example is not limiting. Conventional computer system 130 includes central processing unit (CPU) 132 connected by host bus 134 to various components including main memory 136, storage device controller 138, network interface 140, audio controller 142, and input/output devices 144 connected via input/output (I/O) controllers 146. Those skilled in the art will appreciate that this system encompasses all types of computer systems including, for example, mainframes, minicomputers, workstations, servers, personal computers, Internet terminals, network appliances, notebooks, palm tops, personal digital assistants, and embedded systems.

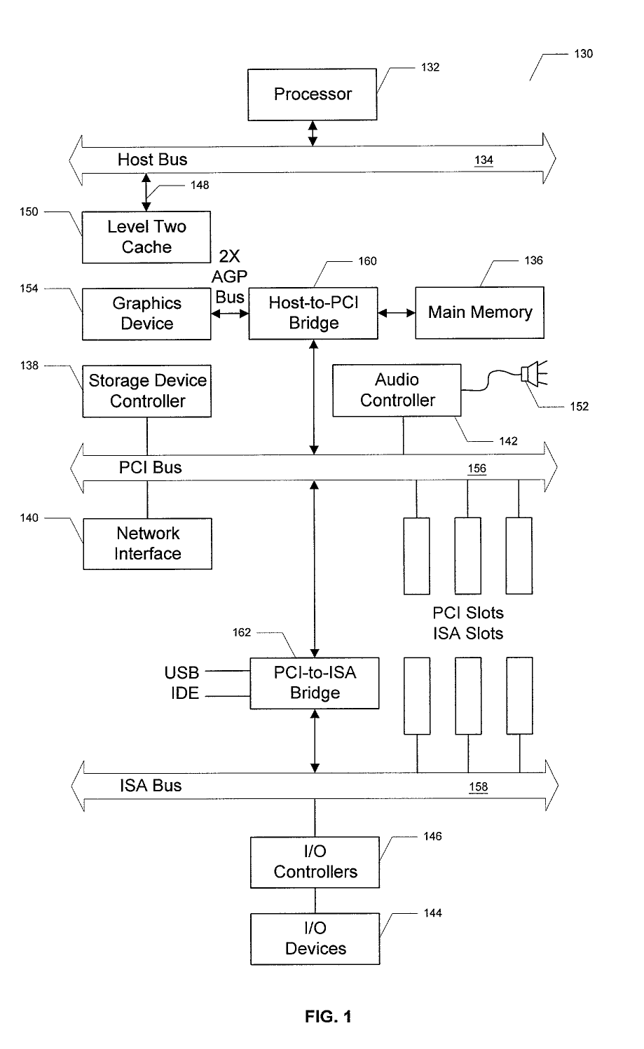

Typically, computer system 130 also includes cache memory 150 to facilitate quicker access between processor 132 and main memory 136. I/O peripheral devices often include speaker systems 152, graphics devices 154, and other I/O devices 144 such as display monitors, keyboards, mouse-type input devices, floppy and hard disk drives, DVD drives, CD-ROM drives, and printers. Many computer systems also include network capability, terminal devices, modems, televisions, sound devices, voice recognition devices, electronic pen devices, and mass storage devices such as tape drives. The number of devices available to add to personal computer systems continues to grow, however computer system 130 may include fewer components than shown in FIG. 1 and described herein. The peripheral devices usually communicate with processor 132 over one or more buses 134, 156, 158, with the buses communicating with each other through the use of one or more bridges 160, 162.

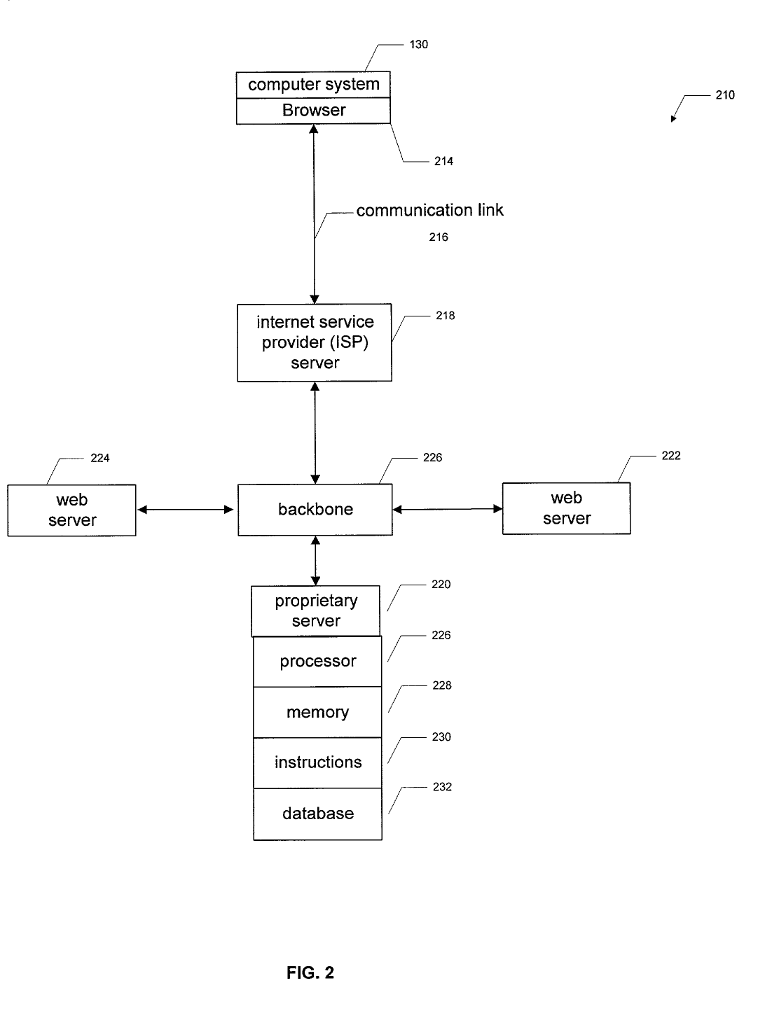

An example of a typical conventional Internet connection is shown in FIG. 2. A user who wishes to access the Internet typically has access to a computer system 130 as shown in FIG. 1. Computer system 130 executes an application program known as a web browser 214. Computer system 130 establishes a communication link 216 with web server (ISP) 218 such as a dial-up wired connection with a modem, a direct link such as a T1, ISDN or DSL line, a wireless connection through a cellular or satellite network. When the user enters a request for information by entering commands in web browser 214, computer system 130 sends a request for information, such as a search for documents pertaining to a specified topic, or a specific web page to web server 218. Each web server 218, 220, 222, 224 connected to the Internet has a known address which the user must supply to the web browser 214 in order to connect to the appropriate web server 218, 220, 222, or 224. If the information is available on the user's web server 218, a central link such as backbone 226 allows web servers 218, 220, 222, 224 to communicate with one another to supply the requested information. Web server 218 services requests for the information and receives information from (or transmits information to) computer system 130.

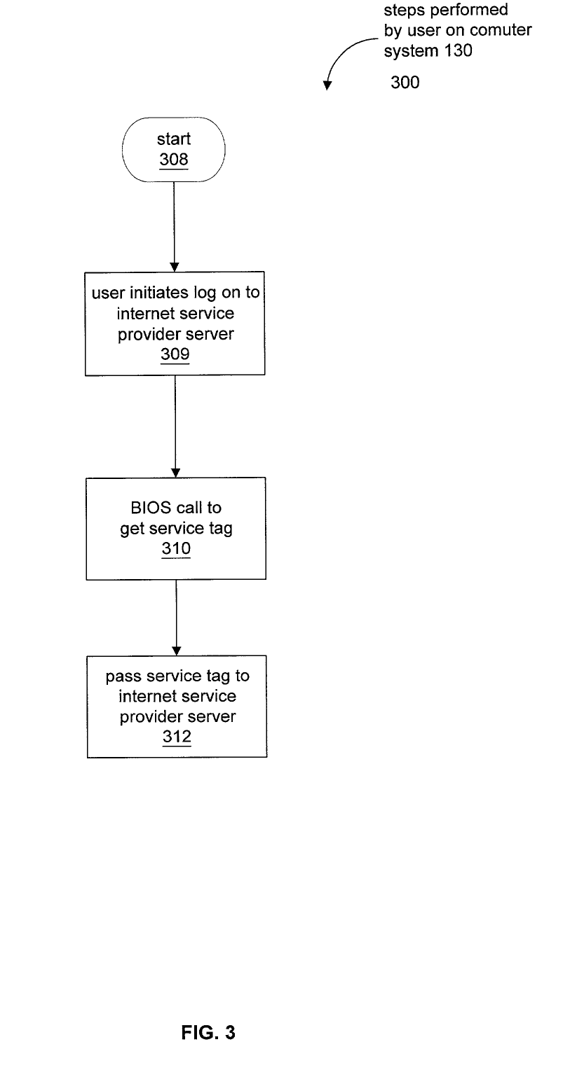

FIGS. 3, 4, 5 and 6 illustrate a method for purchase verification in accordance with the invention. A purchase of access to the internet through the facilities of an internet service provider (ISP) is used as an example here. In this context, the terms “purchase” and “pre-paid” shall be interpreted to mean any situation where the purchaser has ordered a service, benefit, or good and has also made an acceptable provision for payment thereof. For example the purchase of the benefit may have been combined with the purchase of the computer, i.e. the price of the computer included the price of the benefit. In the alternative, the purchaser may have paid separately for the benefit.

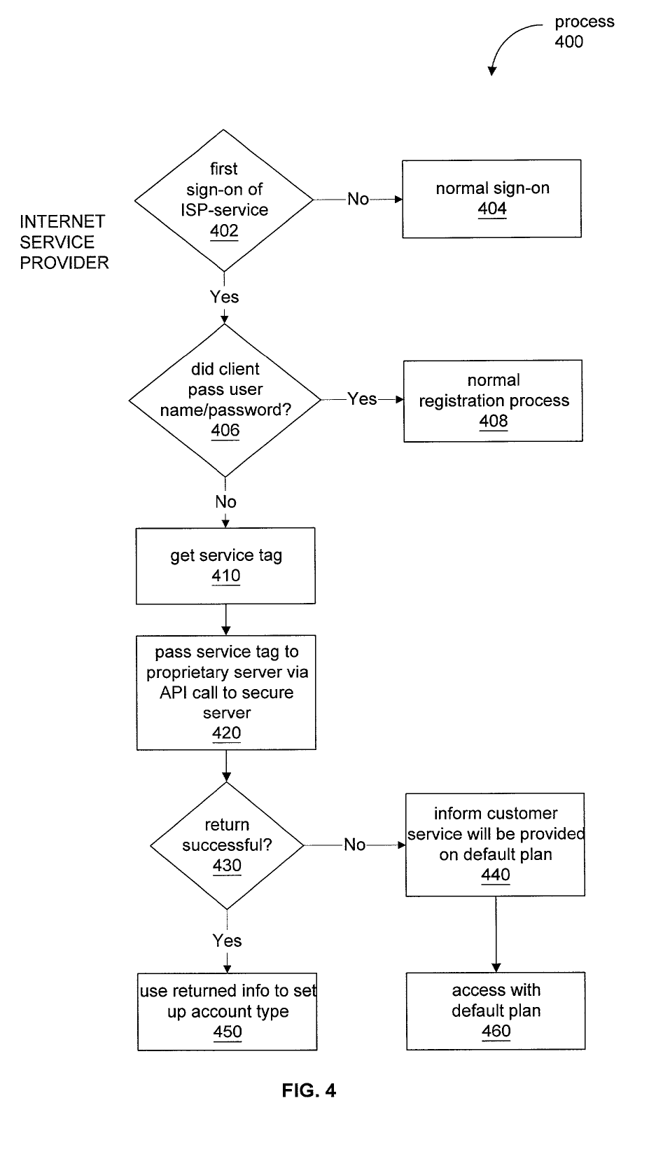

FIG. 3 illustrates the process of the user's computer system 130 reading the service tag from memory. Event 310 reads the service tag from non-volatile read-only memory (ROM) in computer system 130. The service tag is passed to server 218 using a programming interface e.g., as described by Microsoft in a document maintained at web site: http://msdn.microsoft.com/library/winresource/dnwinnt/S75D3.htm. Web server 218 queries a database stored on the server for the service tag and returns: the service tag; service tag and associated product code; service tag and other data associated with the purchase; or an indicia that the service tag is not found. In addition to the application program interface specified, alternate methods of associating a product code with a service tag may be used. Event 310 passes the process to event 312. Event 312 passes the service tag to the internet service provider as illustrated in FIG. 4.

FIG. 4 illustrates purchase verification process 400. The steps illustrated in FIG. 4 are steps performed by web server 218 which is e.g., operated by an internet service provider (ISP). Process 400 begins when a user signs onto the internet as in FIG. 2. Decision 402 determines if the user's sign-on is the first access of the internet for this user on computer system 400. If a user has previously accessed the internet from computer system 130, the user is allowed in event 404 to again sign-on to the internet through a previously established account. If a user has not previously accessed the internet through computer system 130 then decision 402 passes the process to decision 406. Decision 406 allows a user to establish an internet account without utilizing an account purchased incident to purchase of the computer. A user has the option to sign-on the internet without accessing an account purchased incident to the computer system. If a user selects this option decision 406 passes the user's name and password to event 408. If the user decides to access the internet using an account paid for incident to purchase of the computer, decision 406 passes the process to event 410.

Event 410 receives a message containing the service tag stored in the memory of computer system 130. In one embodiment, a service tag is associated with a product code. If a service tag is associated with a product code then Event 310 receives a message containing the service tag and product code stored in the memory of computer system 130. Event 410 passes the process to event 420. Event 420 communicates the service tag to a proprietary server 220. In one embodiment proprietary server 220 is separate from web server 218. In one embodiment, a product code is associated with the service tag.

If a product code is associated with the service tag, Event 420 passes both product code and service tag to proprietary server 220. (In this example, proprietary server 220 is operated by the same entity which originally manufactured computer system 130). As further illustrated in FIG. 4, proprietary server 220 determines if the service tag is stored in its database. As discussed further below, a user is entitled to receive a benefit if the service tag is found in the database but not entitled to receive a benefit if the service tag is not found. If a service tag is found, the customer is entitled to a benefit paid incident to purchase of the computer system. Event 420 passes the process to decision 430 which communicates in a message from the proprietary server 220, whether the user is entitled to a benefit paid incident to purchase of computer system 130.

If the user is entitled to the benefit, e.g., to access the Internet through a pre-paid plan (or some other benefit) decision 430 passes the process to event 450 and the user is allowed to establish and account for access to the Internet. If the user is not entitled to access the Internet through a pre-paid plan, event 430 passes the process to event 440. Event 440 informs the user that he is not entitled to access the Internet through a pre-paid plan and passes the process to event 460. Event 460 allows the user to establish an account using an appropriate payment method to access the Internet.

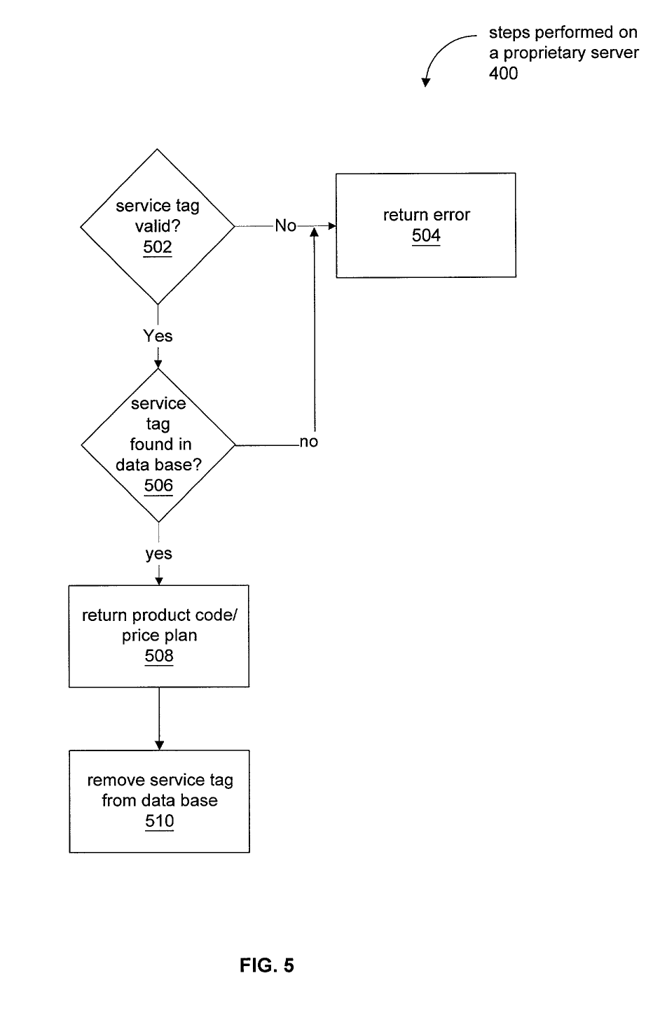

FIG. 5 illustrates the steps in the purchase verification process 500 which are performed by server 218. When proprietary server 220 receives a query from an internet service provider (as shown in event 420 in FIG. 4) decision 502 determines if the service tag is valid. The service tag, for instance, is an alpha-numeric field of varying length, typically less than 64 characters. The value of the service tag uniquely identifies the computer system and is akin to a serial number. In one embodiment, a unique service tag is associated with each computer system 130 with which pre-paid goods or services may be purchased, regardless of whether such goods or services are actually purchased when computer system 130 is ordered from the manufacturer.

If the service tag is found not valid, decision 502 passes the process to event 504. Event 504 returns an error message to the Internet service provider which forwards the error message to the user. (The user then has an opportunity to access the Internet through a default plan or to select an alternative plan.) If the service tag is found valid, then decision 502 passes the process to decision 506. Decision 506 determines if the service tag is found in database 232 of the proprietary server 220. If the service tag is not found in the database 232 of proprietary server 220, then decision 506 passes the process to event 504. When system 130 is ordered or built the service tag and product code if any, is entered into the database 232 on proprietary server 220.

If the service tag is found in the database 232 of the proprietary server 220 then decision 506 passes the service tag and product code to event 508. Event 508 returns the service tag and associated product code to the Internet service provider (as shown in event 420 of FIG. 4) and passes the process to event 510. Event 510 removes the service tag from the data base maintained in the server 220 database to prevent further duplicate accounts for the same user.

In one embodiment, a product code is stored with the service tag in the memory of computer 130 when the computer is assembled. The value of the product code determines whether the purchaser is entitled to benefit from goods and services other than the computer system 130 itself. Proprietary server 220 recalls the service tag from its memory. If the service tag is stored with an associated product code, the product code identifies (in a search as described in the Bueche patent) the additional goods and services to which the purchaser is entitled. In another embodiment, the product code is determined by a price plan associated with the product code. In this embodiment several combinations of goods and services may be offered by the manufacturer in addition to the computer system. For example, the computer manufacturer may offer internet service for 1 year, 2 years or 3 years. In this case, the product code identifies the product as Internet service and the price plan identifies the length of time for which internet service is purchased.

In this embodiment, sales personnel make information available to factory personnel who assemble computer system 130. The factory personnel input the specific purchase information into a system which provides a service tag which uniquely identifies a computer system 130. In one embodiment a product code is associated with the service tag. The product code identifies that additional goods (or goods and services) were purchased incident to purchase of the computer system.

Computer system 130 is conventionally assembled at the manufacturer's factory by a factory installer. The factory installer function may be performed by a person, by a software program, or a by a combination of the two. After the physical components of the computer system 130 are assembled, the appropriate software is configured and installed. In at least one embodiment, this process involves installing the operating system and any other software that the purchaser has requested, including spreadsheet software, games, screensavers, word processing software, educational and reference software, and the like. The factory installer determines whether any additional goods, services, or benefits have been purchased. This determination is based on the information noted by the sales personnel at the time of the purchase. If additional products, services, or benefits (“benefits”) have been purchased, then a product code is also installed. If not, then only a service tag is installed onto the computer system memory at the factory.

The service tag is installed in the system memory. Specifically the service tag can be installed in the basic input/output system (BIOS) which itself is stored in non-volatile memory in the computer. Storing the service tag in the system BIOS prevents the service tag from being lost if the hard disk is formatted. Similarly, the product code, if any, may also be stored in the system hard drive or other memory. A feature in accordance with the invention stores the product code in the memory of proprietary server 220 where it cannot be erased by a user formatting the computer system hard disk. However, software to send the service tag to the Internet service provider server 218 is stored in non-volatile memory in the computer system 130, such as the computer system hard drive, compact disk or other memory.

The operations referred to herein may be embodied as modules or portions of modules (e.g., software, firmware or hardware modules). For example, although the described embodiment includes software modules and/or includes manually entered user, commands, the various examples may be application specific hardware modules. The software modules discussed herein may include script, batch or other executable files, or combinations and/or portions of such files. The software modules may include a computer program or subroutines thereof encoded on computer-readable media and are readily coded by one of ordinary skill in the art in light of this disclosure.

Those skilled in the art will recognize that, based upon the teachings herein, several modifications may be made to the embodiments described above. For example, while the service tag or product code may be used to verify whether a purchaser has pre-paid for ISP services at the time of computer system 130 purchase, the service tag or product code could alternatively be used to verify the purchase of any good, service, or other benefit. In addition, the order of the operations performed in FIGS. 3, 4, 5 and 6 need not necessarily be performed in the exact order set forth in such Figures. Rather, the operations may alternatively be performed in any order that preserves the function described herein. One skilled in the art will recognize that, although the provider in the main embodiment attempts to verify the product code using a remote server over a network connection, the verification process need not occur over a network.

Particular embodiments of the present invention have been shown and described. It will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. A method for purchase verification, comprising the acts of:
receiving at a server a first message from a computer system, the first message including a service tag, the service tag identifying the computer system;
determining at the server if the service tag is valid; and
generating a second message from the server, the second message authorizing providing a benefit if the service tag is determined to be valid.

2. The method as recited in claim 1, wherein the server includes a processor coupled to a memory, further comprising the act of:
invalidating the service tag after generating the second message.

3. The method as recited in claim 1, wherein the first message includes a product code.

4. A method for purchase verification, comprising the acts of:
generating a service tag that identifies a computer system, the computer system including a processor coupled to a memory;
storing the service tag in the memory at assembly of the computer system;
receiving a message at a server sent from the computer system, the message including the service tag;
verifying that the service tag value as received matches a service tag value stored in the server; and
authorizing receipt of a benefit if the received service tag matches.

5. The method as recited in claim 4, wherein the service tag is stored as part of the computer system basic input/output operating system.

6. The method as recited in claim 4, further comprising the act of:
generating a second message, the message authorizing a purchaser to receive the benefit, if the service tag matches.

7. The method as recited in claim 5, wherein the benefit is Internet Service Provider service.

8. A method for purchase verification of a benefit, comprising the acts of:
receiving a first message at a first server, the first message being sent from a computer system, the first message including a service tag;
transmitting a second message from the first server to a second server, the second server attempting to verify the validity of the service tag; and
transmitting from the second server a third message to the first server, the third message allowing access to the benefit.

9. The method as recited in claim 8, wherein the first message includes a product code.

10. The method as recited in claim 8, further comprising the act of:
invalidating the service tag on the second server.

11. A system in a computer system for purchase verification, the computer system including a processor, the system comprising:
a non-volatile computer readable memory, the non-volatile computer readable memory including:
instructions, executable on the processor, configured to store a service tag installed upon assembly of the computer system, the service tag identifying the computer system; and
instructions, executable on the processor, configured to send the service tag to a remote server.

12. The system as recited in claim 11, further comprising:
instructions, executable on the processor, configured to store a product code, the product code identifying a benefit.

13. The system as recited in claim 11, further comprising:
instructions, executed on the processor, configured to communicate with a remote server, the server having the ability to verify the service tag.

14. A system for purchase verification, the system being on a server platform, the server operated by a service provider, the server configured to communicate with a purchased computer system, the server including a processor and a memory, the server platform configured to communicate with a remote computer system, the system comprising:
a non-volatile computer readable memory, the non-volatile computer readable memory storing:
a database, the database including a set of valid service tags; and
instructions, executable on the processor, configured to receive a message, the message including a service tag.

15. The system as recited in claim 14, further comprising:
instructions, executable on the processor, configured to receive a message, the message including a product code.

16. The system as recited in claim 15, further comprising:
instructions, executable on the processor, configured to authorize a purchaser to receive a benefit.

17. The system as recited in claim 14, further comprising:
instructions executable on the processor, configured to verify the service tag, wherein the instructions to verify the service tag further comprise:
instructions to receive the service tag from the computer system;
instructions to recall the service tag stored in the server; and
instructions to compare the service tag received from the computer system to the service tag recalled from the server to determine if the service tag received from the computer system matches the service tag recalled from the server.

18. The system as recited in claim 17, further comprising:
instructions, executable on the processor, configured to authorize a purchaser to receive a benefit if the service tag received from the computer system matches the service tag recalled from the server.

19. The system recited in claim 17, further comprising:
instructions, executable on the processor, configured to establish an internet service provider service account if the service tag received from a computer system matches the service tag recalled from the server.

20. The computer system as recited in claim 17, further comprising:
instructions, executable on the processor, configured to invalidate the service tag stored in the memory of the server.
